(19) United States
(12) Patent Application Publication
(10) Pub. No.: US 2005/0225900 A1
(43) Pub. Date: Oct. 13, 2005

(54) Magnetic recording media and production thereof, and, magnetic recording apparatus and method

(75) Inventors: Kenichi Itoh, Kawasaki (JP); Tsugio Kumai, Tokyo (JP); Shintaro Sato, Kawasaki (JP); Koji Matsumoto, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/146,094

(22) Filed: Jun. 7, 2005

Related U.S. Application Data
(63) Continuation of application No. PCT/JP03/03338, filed on Mar. 19, 2003.

(51) Int. Cl. G11B 5/82; G11B 5/147

(52) U.S. Cl. 360/135; 360/126

(57) ABSTRACT

A magnetic recording medium of the present invention includes a substrate and a porous layer on or above the substrate. The porous layer contains a plurality of pores each extending in a direction substantially perpendicular to a substrate plane and having a soft magnetic layer and a ferromagnetic layer inside in this order from the substrate side. The ferromagnetic layer has any one of (1) a thickness equal to or less than that of the soft magnetic layer, (2) a thickness one-thirds to three times a minimum bit length, the minimum bit length being determined by a linear recording density in recording, and (3) a thickness equal to or less than the total thickness of the soft magnetic layer and the soft magnetic underlayer.

### CROSS-REFERENCE TO RELATED APPLICATIONS

This is a continuation of Application PCT/JP2003/003338, filed on Mar. 19, 2003.

### BACKGROUND OF THE INVENTION

1. Field of the Invention

The present invention relates to magnetic recording media which are useful in hard disk devices widely used as external storage for computers, and consumer-oriented video recorders, have a large capacity and enable high-speed recording, and methods for efficiently manufacturing the magnetic recording media at low cost; and relates to apparatus and methods for perpendicular magnetic recording using the magnetic recording media.

2. Description of the Related Art

In recent years, due to rapid progress in the IT industry, research is being actively pursued to increase the capacity, increase the speed and reduce the cost of magnetic recording media. To achieve higher capacity, higher speeds and lower costs of these magnetic recording media, the recording density of the magnetic recording media must be increased. It has been attempted to increase the recording density in a magnetic recording medium by horizontally recording information on a continuous magnetic film in the medium. However, this technology almost reaches its limit. If crystal grains of magnetic particles constituting the continuous magnetic film have a large size, a complex magnetic domain structure is formed to thereby increase noise. In contrast, if the magnetic particles have a small size to avoid increased noise, the magnetization decreases with time due to thermal fluctuations, thus inviting errors. In addition, a demagnetizing field for recording relatively increases with an increasing recording density of the magnetic recording medium. Thus, the magnetic recording medium must have an increased coercive force and do not have sufficient overwrite properties due to insufficient writing ability of a recording head.

Intensive investigations on novel recording systems as an alternative for the horizontal recording system have been made recently. One of them is a recording system using a patterned magnetic recording medium, in which a magnetic film in the medium is not a continuous film but is in the pattern of, for example, dot, bar or pillar on the order of nanometers and thereby constitutes not a complex magnetic domain structure but a single domain structure (e.g., S. Y. Chou Proc. IEEE 85 (4), 652 (1997)). Another is a perpendicular recording system, in which a recording demagnetization field is smaller and information can be recorded at a higher density than in the horizontal recording system, the recording layer can have a somewhat large thickness and the recording magnetization is resistant to thermal fluctuations (e.g., Japanese Patent Application Laid-Open UP-A) No. 06-180834). On the perpendicular recording system, JP-A No. 52-134706 proposes a combination use of a soft magnetic film and a perpendicularly magnetized film. However, this technique is insufficient in writing ability with a magnetic monopole head. To avoid this problem, JP-A No. 2001-283419 proposes a magnetic recording medium further comprising a soft magnetic underlayer. Such magnetic recording on a magnetic recording medium according to the perpendicular recording system is illustrated in FIG. 1. A read-write head (single pole head) of perpendicular-magnetic-recording system has a main pole 52 facing a recording layer 30 of the magnetic recording medium. The magnetic recording medium comprises a substrate, a soft magnetic layer 10, an interlayer (nonmagnetic layer) 20 and a recording layer (perpendicularly magnetized film) 30 arranged in this order. The main pole 52 of the read-write head (single pole head) supplies a recording magnetic field toward the recording layer (perpendicularly magnetized film) 30 at a high magnetic flux density. The recording magnetic field flows from the recording layer (perpendicularly magnetized film) 30 via the soft magnetic layer 10 to a latter half portion 50 of the read-write head to form a magnetic circuit. The latter half portion 50 has a portion facing the recording layer (perpendicularly magnetized film) 30 with a large size, and thereby its magnetization does not affect the recording layer (perpendicularly magnetized film) 30.

The patterned magnetic film requires complicated patterning procedures and thus is expensive. In the magnetic recording medium having the soft magnetic underlayer, the soft magnetic underlayer must be arranged at a close distance from the single pole head in magnetic recording. Otherwise, a magnetic flux extending from main pole 52 of the read-write head (single pole head) to the soft magnetic underlayer 10 diverge with an increasing distance between the two components, and information is recorded in a broadened magnetic field with larger bits in the lower part of the recording layer (perpendicularly magnetized film) 30 arranged on the soft magnetic underlayer 10 (FIG. 2A). In this case, the read-write head (single pole head) must supply an increasing write current. In addition, if a small bit is recorded after recording a large bit, a large portion of the large bit remains unerased, thus deteriorating the overwrite properties.

Certain magnetic recording medium according to the perpendicular recording system and the recording system using the patterned medium are proposed, for example, in JP-A No. 2002-175621. This type of magnetic recording media comprises a magnetic metal charged into pores of anodized alumite, on which information is recorded according to the perpendicular recording system using the patterned magnetic recording medium. More specifically, the magnetic recording medium comprises a substrate 100, an underlying electrode layer 120 and a anodized alumite layer 130 arranged in this order (FIG. 3). The anodized alumite layer 130 includes a plurality of alumite pores 140 arrayed regularly, and the alumite pores are filled with a ferromagnetic metal to form a ferromagnetic layer.

However, the anodized alumite layer 130 must have a thickness exceeding 500 nm so as to form regularly arrayed alumite pores 140 therein, and even if the soft magnetic underlayer is provided, the distance between the single pole head and soft magnetic underlayer increases, so information cannot be recorded therein at a high density. To solve this problem, an attempt has been made to polish the anodized alumite layer 130 to reduce its thickness. However, the polishing is difficult and takes a long time to perform, thus inviting higher cost and deteriorated quality of the product. In fact, to magnetically record information at a linear recording density of 1500 kBPI to realize a recording density of 1 Tb/in², the distance between the single pole head and the soft magnetic underlayer must be reduced to about 25 nm, and the thickness of the anodized alumite layer 130 must be reduced to about 20 nm. It takes much time and effort to polish the anodized alumite layer 130 to such a thickness.

Accordingly, an object of the present invention is to solve the above problems in conventional technologies and to provide a high-quality, high-capacity magnetic recording medium which is useful in, for example, hard disk devices widely used as external storage for computers and consumer-oriented video recorders, enables recording of information at high density and high speed without increasing a write current of a magnetic head and exhibits satisfactory and uniform properties such as overwrite properties. Another object of the present invention is to provide a method for efficiently manufacturing the magnetic recording medium at low cost. A further object of the present invention is to provide an apparatus and method for perpendicular magnetic recording using the magnetic recording medium, which enable high-density recording.

### SUMMARY OF THE INVENTION

A magnetic recording medium according to a first aspect of the present invention comprises a substrate; and a porous layer on or above the substrate, which porous layer comprises a plurality of pores, the pores each extending in a direction substantially perpendicular to a substrate plane, wherein the pores each have a soft magnetic layer and a ferromagnetic layer inside in this order from the substrate side, and wherein the ferromagnetic layer has a thickness equal to or less than that of the soft magnetic layer.

In the magnetic recording medium, the ferromagnetic layer is arranged on or above the soft magnetic layer inside the pores of the porous layer and has a thickness less than that of the porous layer. When magnetic recording is carried out on the magnetic recording medium using a single pole head, the distance between the single pole head and the soft magnetic layer is less than the thickness of the porous layer and is substantially equal to the thickness of the ferromagnetic layer. Thus, the convergence of a magnetic flux from the single pole head and the optimum properties for magnetic recording and reproduction at a recording density can be controlled only by controlling the thickness of the ferromagnetic layer, regardless of the thickness of the porous layer. As shown in FIGS. 2B and 4, the magnetic flux from the main pole 52 of the single pole head converges to the ferromagnetic layer (perpendicularly magnetized film) 30 (reference numbers 10, 15, and 25 represent a soft magnetic underlayer, soft magnetic layer and porous layer, respectively). As a result, the magnetic recording medium exhibits significantly increased write efficiency, requires a decreased write current and has markedly improved overwrite properties as compared with conventional equivalents.

A magnetic recording medium according to a second aspect of the present invention comprises a substrate; and a porous layer on or above the substrate, which porous layer comprises a plurality of pores, the pores each extending in a direction substantially perpendicular to a substrate plane, wherein the pores each have a soft magnetic layer and a ferromagnetic layer inside in this order from the substrate side, and wherein the ferromagnetic layer has a thickness one-thirds to three times a minimum bit length, the minimum bit length being determined by a linear recording density in recording.

In the magnetic recording medium, the ferromagnetic layer is arranged on or above the soft magnetic layer inside the pores of the porous layer and has a thickness one-thirds to three times a minimum bit length which is determined by a linear recording density in recording. When magnetic recording is carried out on the magnetic recording medium using a single pole head, in the magnetic recording medium, the convergence of a magnetic flux from the single pole head and the optimum properties for magnetic recording and reproduction at a recording density can be controlled. As shown in FIGS. 2B and 4, the magnetic flux from the main pole 52 of the single pole head converges to the ferromagnetic layer (perpendicularly magnetized film) 30. As a result, the magnetic recording medium exhibits significantly increased write efficiency, requires a decreased write current and has markedly improved overwrite properties as compared with conventional equivalents.

A magnetic recording medium according to a third aspect of the present invention comprises a substrate; a soft magnetic underlayer on the substrate; and a porous layer on the soft magnetic underlayer, which porous layer comprises a plurality of pores, the pores each extending in a direction substantially perpendicular to a substrate plane, wherein the pores each have a soft magnetic layer and a ferromagnetic layer inside in this order from the substrate side, and wherein the ferromagnetic layer has a thickness equal to or less than the total thickness of the soft magnetic layer and the soft magnetic underlayer.

In the magnetic recording medium, the ferromagnetic layer has a thickness equal to or less than the total thickness of the soft magnetic layer and the soft magnetic underlayer, is arranged on or above the soft magnetic layer inside the pores of the porous layer on the soft magnetic underlayer and has a thickness less than that of the porous layer. When magnetic recording is carried out on the magnetic recording medium using a single pole head, the distance between the single pole head and the soft magnetic layer is less than the thickness of the porous layer and is substantially equal to the thickness of the ferromagnetic layer. Thus, the convergence of a magnetic flux from the single pole head and the optimum properties for magnetic recording and reproduction at a recording density can be controlled only by controlling the thickness of the ferromagnetic layer, regardless of the thickness of the porous layer. As shown in FIGS. 2B and 4, the magnetic flux from the main pole 52 of the single pole head converges to the ferromagnetic layer (perpendicularly magnetized film) 30. As a result, the magnetic recording medium exhibits significantly increased write efficiency, requires a decreased write current and has markedly improved overwrite properties as compared with conventional equivalents.

The method for manufacturing a magnetic recording medium of the present invention is a method of manufacturing the magnetic recording medium of the present invention, and comprises the processes of: forming a porous layer comprising a plurality of pores, the process of forming a porous layer comprising forming a soft magnetic underlayer on a substrate, forming a layer of porous layer-forming material thereon, and then treating the layer of porous layer-forming material to form the pores extending in a direction substantially perpendicular to a substrate plane the porous layer to thereby form the porous layer; forming a soft magnetic layer inside the pores; and forming a ferromagnetic layer on the soft magnetic layer.

In the method of manufacturing the magnetic recording medium, the layer of porous layer-forming material is formed on a substrate, and then is subjected to pores forming treatment to thereby form a plurality of pores extending in a direction substantially perpendicular to the substrate plane in the process for forming the nanohole structure in the process of forming a porous layer. In the process of forming a soft magnetic layer, a soft magnetic layer is formed inside the pores. In the process of forming a ferromagnetic layer, a ferromagnetic layer is formed on the soft magnetic layer. Thus, the magnetic recording medium of the present invention is manufactured.

The magnetic recording apparatus of the present invention comprises the magnetic recording medium of the present invention and a perpendicular-magnetic-recording head.

In the magnetic recording apparatus, information is magnetically recorded on the magnetic recording medium of the present invention using the perpendicular-magnetic-recording head. In the magnetic recording medium, the ferromagnetic layer is arranged on or above the soft magnetic layer inside the pores of the porous layer and has a thickness less than that of the porous layer. Therefore, when magnetic recording is carried out on the magnetic recording medium using the perpendicular-magnetic-recording head such as a single pole head, the distance between the perpendicular-magnetic-recording head and the soft magnetic layer is less than the thickness of the porous layer and is substantially equal to the thickness of the ferromagnetic layer. Thus, the convergence of a magnetic flux from the perpendicular-magnetic-recording head and the optimum properties for magnetic recording and reproduction at a recording density in practice can be controlled only by controlling the thickness of the ferromagnetic layer, regardless of the thickness of the porous layer. When magnetic recording is carried out using the magnetic recording apparatus, as shown in FIGS. 2B and 4, the magnetic flux from the main pole 52 of the single pole head converges to the ferromagnetic layer (perpendicularly magnetized film) 30. As a result, the magnetic recording media exhibit significantly increased write efficiency, require a decreased write current and have markedly improved overwrite properties as compared with conventional equivalents.

The magnetic recording method of the present invention comprises recording information on the magnetic recording medium of the present invention with the use of a perpendicular-magnetic-recording head.

In the magnetic recording method, information is magnetically recorded on the magnetic recording medium of the present invention using the perpendicular-magnetic-recording head. In the magnetic recording medium, the ferromagnetic layer is arranged on or above the soft magnetic layer inside the pores of the porous layer and has a thickness less than that of the porous layer. Therefore, when magnetic recording is carried out on the magnetic recording medium using the perpendicular-magnetic-recording head such as a single pole head, the distance between the perpendicular-magnetic-recording head and the soft magnetic layer is less than the thickness of the porous layer and is substantially equal to the thickness of the ferromagnetic layer. Thus, the convergence of a magnetic flux from the perpendicular-magnetic-recording head and the optimum properties for magnetic recording and reproduction at a recording density in practice can be controlled only by controlling the thickness of the ferromagnetic layer, regardless of the thickness of the porous layer. When magnetic recording is carried out using the magnetic recording method, as shown in FIGS. 2B and 4, the magnetic flux from the main pole 52 of the single pole head converges to the ferromagnetic layer (perpendicularly magnetized film) 30. As a result, the magnetic recording media exhibit significantly increased write efficiency, require a decreased write current and have markedly improved overwrite properties as compared with conventional equivalents.

### BRIEF DESCRIPTION OF THE DRAWINGS

FIG. 1 is a diagram schematically illustrating an example of magnetic recording according to the perpendicular magnetic recording system using conventional magnetic recording medium.

FIG. 2A is a schematic diagram showing an example of the divergence of a magnetic flux in perpendicular magnetic recording using conventional magnetic recording medium and FIG. 2B is a schematic diagram showing an example of the convergence of a magnetic flux in perpendicular magnetic recording using the magnetic recording medium of the present invention.

FIG. 3 is a schematic diagram illustrating an example of a magnetic recording medium in the related art which is a patterned medium and enables perpendicular recording, wherein anodized alumite pores are filled with a magnetic metal.

FIG. 4 is a schematic partial sectional view illustrating an example of perpendicular-magnetic-recording on the magnetic recording medium of the using a single pole head.

FIG. 5 is a graph illustrating signal-to-noise ratios and overwrite properties of the magnetic recording medium of the present invention and of a conventional magnetic recording medium.

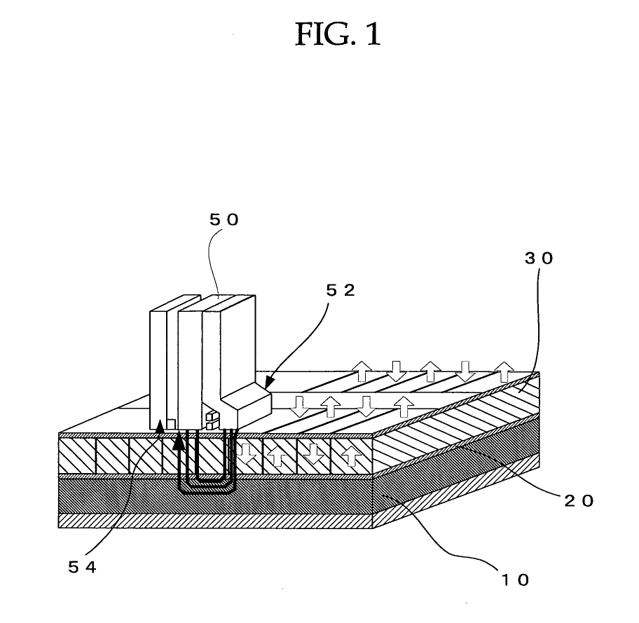

### DESCRIPTION OF THE PREFERRED EMBODIMENTS

(Magnetic Recording Medium)

The magnetic recording media according to the present invention comprise a substrate and a porous layer and may further comprise any other layers selected according to necessity.

This porous layer comprises a plurality of pores extending in a direction substantially perpendicular to the substrate plane. Inside the pores, the soft magnetic layer and the ferromagnetic layer are arranged in this order from the substrate side. Where necessary, a nonmagnetic layer (interlayer) may be formed between the ferromagnetic layer and the soft magnetic layer.

The magnetic recording medium of the present invention may take several forms, e.g., a first aspect wherein the ferromagnetic layer has a thickness equal to or less than that of the soft magnetic layer, a second aspect wherein the ferromagnetic layer has a thickness one-thirds to three times a minimum bit length, the minimum bit length being determined by a linear recording density in recording, a third aspect wherein the ferromagnetic layer has a thickness equal to or less than the total thickness of the soft magnetic layer and the soft magnetic underlayer, and a fourth aspect wherein two or more of these aspects are combined.

The substrate can have any suitable shape, structure and size and comprise any suitable material according to the purpose. The substrate preferably has a disk shape when the magnetic recording medium is a magnetic disk such as hard disk. It can have a single layer structure or a multi-layer structure. The material can be selected from known materials for substrates of magnetic recording media and can be, for example, aluminium, glass, silicon, quartz or SiO₂/Si comprising a thermal oxide film on silicon. Each of these materials can be used alone or in combination. The substrate can be suitably prepared or is available as a commercial product.

The porous layer is not particularly limited provided that pores are formed in a direction substantially perpendicular to the substrate plane, and may be suitably selected according to the purpose, but specific examples of suitable materials are alumite (aluminum oxide) and porous silica, and its structure may be single-layer or multi-layer.

The opening diameter of the pores is not particularly limited provided that the ferromagnetic layer can become a single domain structure and may be suitably selected according to the purpose, but the diameter is preferably 100 nm or less, and more preferably 5 to 60 nm.

If the opening diameter of the pores exceeds 100 nm, a single magnetic domain may not be formed.

The arrangement of the pores on the surface of the porous layer is not particularly limited and may be suitably selected according to the purpose, but it is preferably a regular arrangement, e.g., a honeycomb array or square lattice array is more preferred, but among these, from the viewpoint that the pores can be arranged in a uniform, close-packed arrangement, a honeycomb array is particularly preferred.

The aspect ratio, i.e., a ratio of the depth to the opening diameter of the pores is not particularly limited and may be suitably selected according to the purpose. A high aspect ratio is preferable for higher anisotropy in dimensions and for higher coercive force of the magnetic recording medium, so the aspect ratio is preferably 2 or more, and more preferably 3 to 15.

An aspect ratio less than 2 may invite insufficient coercive force of the magnetic recording medium.

The thickness of the porous layer is not particularly limited and may be suitably selected according to the purpose, but it is preferably 500 nm or less, more preferably 300 nm or less and still more preferably 20 to 200 nm.

If the thickness of the porous layer exceeds 500 nm, high-density recording may not be possible even if the soft magnetic underlayer is provided in the magnetic recording medium. Thus, the porous layer must be polished to reduce its thickness and the production of the magnetic recording medium may take a long time, invite higher cost and lead to deteriorated quality.

The porous layer may be formed according to any method known in the art without particular limitation, e.g., a continuous film of porous material is formed by sputtering or vapor deposition, and the pores are then formed by etching, such as by anodic oxidation method.

The ferromagnetic layer functions as a recording layer in the magnetic recording medium and constitutes magnetic layers together with the soft magnetic layer.

The material of this ferromagnetic layer is not particularly limited and may be suitably selected from known materials according to the purpose, but may be at least one selected from among Fe, Co, Ni, FeCO, FeNi, CoNi, CoNiP, FePt, CoPt and NiPt.

These may be used alone, or two or more may be used in combination.

The ferromagnetic layer is not particularly limited provided that it is formed as a perpendicularly magnetized film and by the material, and may be suitably selected according to the purpose. Suitable examples thereof are one having a L1₀ ordered structure with the C axis oriented in a direction perpendicular to the substrate, and one having a fcc structure or bcc structure with the C axis oriented in a direction perpendicular to the substrate.

The thickness of the ferromagnetic layer is not particularly limited provided that it has no adverse effect on the present invention, and may be suitably selected according to the linear recording density used for recording, but for example in the case of the first aspect, it must be equal to or less than the thickness of the soft magnetic layer, in the case of the second aspect, it must be one-thirds to three times the minimum bit length determined by the linear recording density in recording, and in the case of the third aspect, it must be equal to or less than the total thickness of the soft magnetic layer and soft magnetic underlayer. It is generally preferably from about 5 to about 100 nm, and more preferably from about 5 to 50 nm. It is preferably 50 nm or less (around 20 nm) in magnetic recording at a linear recording density of 1500 kBPI at a target density of 1 Tb/in².

The thickness of the “ferromagnetic layer” in the first to fourth aspects means a total of individual ferromagnetic layers when the ferromagnetic layer comprises plural continuous layers or plural separated layers, for example, in the case where the ferromagnetic layer is partitioned by one or more interlayers such as nonmagnetic layers and constitutes discontinuous separated ferromagnetic layers. The thickness of the “soft magnetic layer” in the first aspect means a total thickness of individual soft magnetic layers when the soft magnetic layer comprises plural continuous layers or plural separated layers, for example, in the case where the soft magnetic layer is partitioned by one or more interlayers such as nonmagnetic layers and constitutes discontinuous soft magnetic layers. The “total thickness of the soft magnetic layer and the soft magnetic underlayer” in the third aspect means a total of individual soft magnetic layers and soft magnetic underlayers when at least one of the soft magnetic layer and the soft magnetic underlayer comprises plural continuous layers or plural separated layers, for example, in the case where the soft magnetic layer or the soft magnetic underlayer is partitioned by one or more interlayers such as nonmagnetic layers and constitutes discontinuous soft magnetic (under) layers.

According to the magnetic recording media of the present invention, the distance between the single pole head and the soft magnetic layer in magnetic recording can be less than the thickness of the porous layer and substantially equal to the thickness of the ferromagnetic layer. Thus, the convergence of a magnetic flux from the single pole head and the optimum properties for magnetic recording and reproduction at a recording density in practice can be controlled only by controlling the thickness of the ferromagnetic layer, regardless of the thickness of the porous layer. As a result, the magnetic recording media exhibit significantly increased write efficiency, require a decreased write current and have markedly improved overwrite properties as compared with conventional equivalents.

The ferromagnetic layer can be formed according to any suitable procedure such as electrodeposition.

The soft magnetic layer can be formed from any suitable material according to the purpose, such as NiFe, FeSiAl, FeC, FeCoB, FeCoNiB and CoZrNb. These materials can be used alone or in combination.

These materials can be used alone or in combination.

The thickness of the soft magnetic layer is not particularly limited and may be suitably selected depending on the depth of the pores of the porous layer and the thickness of the ferromagnetic layer. For example, (1) the thickness of the soft magnetic layer or (2) the total thickness of the soft magnetic layer and the soft magnetic underlayer may be larger than the thickness of the ferromagnetic layer.

The soft magnetic layer advantageously serves to converge a magnetic flux from the magnetic head in magnetic recording effectively to the ferromagnetic layer to thereby increase the vertical component of magnetic field of the magnetic head. Also, The soft magnetic layer and the soft magnetic underlayer preferably constitute a magnetic circuit of a recording magnetic field supplied from the magnetic head.

The soft magnetic layer can be formed according to any method known in the art without particular limitation, e.g., by electrodeposition or the like.

The pores of the porous layer may further include a nonmagnetic layer (interlayer) between the ferromagnetic layer and the soft magnetic layer. The nonmagnetic layer (interlayer) works to reduce the action of an exchange coupling force between the ferromagnetic layer and the soft magnetic layer to thereby control and adjust the reproduction properties in magnetic recording at desired levels.

The material of the nonmagnetic layer is not particularly limited and may be suitably selected from among those known in the art, e.g., at least one selected from among Cu, Al, Cr, Pt, W, Nb and Ti.

These may be used alone, or two or more may be used in combination.

The thickness of the nonmagnetic layer is not particularly limited and may be suitably selected according to the purpose.

The nonmagnetic layer can be formed according to any method known in the art without particular limitation, e.g., by electrodeposition or the like.

In the first aspect and second aspect, a soft magnetic underlayer may be provided between the substrate and porous layer, and in the case of the third aspect, a soft magnetic underlayer must be provided.

The material of the soft magnetic underlayer is not particularly limited and may be suitably selected from among those known in the art, e.g., the materials mentioned for the aforesaid soft magnetic layer may be used. Each of these materials can be used alone or in combination. The material for the soft magnetic underlayer can be the same as or different from that for the soft magnetic layer.

The soft magnetic underlayer preferably has its axis of easy magnetization in an in-plane direction of the substrate. In this case, the magnetic flux from the magnetic head used for magnetic recording can effectively form a closed magnetic circuit, and the vertical component of the magnetic field of the magnetic head can be increased.

The soft magnetic underlayer can be formed according to any method known in the art without particular limitation, e.g., by electrodeposition or the like.

The other layers are not particularly limited and may be suitably selected according to the purpose, e.g., an electrode layer, protective layer or the like.

The electrode layer is a layer which functions as an electrode when the magnetic layer (including the ferromagnetic layer and the soft magnetic layer) is formed by electrodeposition, and is generally provided on the substrate and underneath the ferromagnetic layer. When the magnetic layer is formed by electrodeposition, the electrode layer may be used as an electrode, but the soft magnetic underlayer may also be used as the electrode.

The material of the electrode layer is not particularly limited and may be suitably selected according to the purpose, e.g., Cr, Co, Pt, Cu, Ir, Rh or alloys thereof. These may be used alone, or two or more may be used in combination. This electrode layer may further contain W, Nb, Si and O or the like in addition to these materials.

The thickness of the electrode layer is not particularly limited and may be suitably selected according to the purpose. Only one electrode layer, or two or more may be provided.

The electrode layer can be formed according to any method known in the art without particular limitation, e.g., by sputtering or vapor deposition.

The protective layer is a layer which functions to protect the ferromagnetic layer, and is provided on or above the surface of the ferromagnetic layer. Only one protective layer may be provided, two or more may be provided, and they may have a single layer structure or a multi-layer construction.

The material of the protective layer is not particularly limited and may be suitably selected according to the purpose, e.g., diamond-like carbon (DLC) or the like.

The thickness of the protective layer is not particularly limited and may be suitably selected according to the purpose.

The protective layer can be formed according to any method known in the art without particular limitation, e.g., by plasma CVD, coating or the like.

The magnetic recording media can be used in various magnetic recording systems using a magnetic head, are useful in magnetic recording using a single pole head and are typically useful in the magnetic recording apparatus and magnetic recording method according to the present invention mentioned later.

The magnetic recording media enable recording of information at high density and high speed with a high storage capacity without increasing a write current of the magnetic head, exhibit satisfactory and uniform properties such as overwrite properties and are of very high quality. Consequently, they can be designed and used as a variety of magnetic recording media. For example, they can be designed and used as magnetic disks such as hard disks in hard disk devices widely used as external storage for computers and consumer-oriented video recorders.

The magnetic recording media can be manufactured according to any method known in the art without particular limitation, but particularly by the method for manufacturing the magnetic recording medium of the present invention described below.

(Method for Manufacturing a Magnetic Recording Medium)

The method for manufacturing a magnetic recording medium of the present invention is a method of manufacturing the magnetic recording medium of the present invention, comprises a porous layer forming process, a soft magnetic layer forming process and a ferromagnetic layer forming process, and may further comprise one or more of other processes suitably selected according to the necessity, such as a soft magnetic underlayer forming process, nonmagnetic layer forming process, and protective layer forming process.

The soft magnetic underlayer forming process is a process for forming a soft magnetic underlayer on the substrate.

The substrate may be any of the above-mentioned substrates.

The soft magnetic underlayer can be formed according to any method known in the art such as sputtering, vapor deposition or another vacuum film forming method, as well as electrodeposition or electroless plating.

Due to the soft magnetic underlayer forming process, the soft magnetic underlayer is formed on the substrate.

The porous layer forming process is a process for forming a porous layer, wherein, a layer of porous layer-forming material is formed on a substrate (if the magnetic underlayer is formed by the soft magnetic underlayer forming process, it is formed on the soft magnetic underlayer), and then the layer of porous layer-forming material is subjected to pores forming treatment to thereby form a plurality of pores each extending in a direction substantially perpendicular to a substrate plane.

The porous layer-forming material may be any of those mentioned above as the material of the porous layer. For example, alumite (aluminum oxide) and porous silica are preferred.

The layer of porous layer-forming material may be formed according to any method known in the art, e.g., sputtering, vapor deposition or the like. The conditions for forming the layer of porous layer-forming material are not particularly limited and may be suitably selected according to the purpose. In the case of sputtering, sputtering may be performed using a target of the aforesaid porous layer-forming material. The target used in this case is preferably high purity, and if the porous layer-forming material is aluminum, it is preferably 99.990% or more.

The pores forming treatment is not particularly limited and may be suitably selected according to the purpose, e.g., anodic oxidation, etching or the like. Among these, anodic oxidation is particularly preferred from the viewpoint that a plurality of pores can be formed substantially perpendicular to the substrate plane in the layer of porous layer-forming material at substantially equal intervals so as to form a uniform array.

In the case of anodic oxidation, an electrode in contact with the layer of porous layer-forming material is used as an anode for electrolytic etching in an aqueous solution of sulfuric acid or oxalic acid. This electrode may be the soft magnetic underlayer or electrode layer which is formed prior to forming the layer of porous layer-forming material. The temperature, voltage and time when the layer of porous layer-forming material is etched are not particularly limited, and may be suitably selected according to the number, size and aspect ratio of the pores formed, but a voltage of about 5 to 100 V is sufficient.

When the pores forming treatment is performed by anodic oxidation method, pores are formed in the layer of porous layer-forming material, but a barrier layer may be formed in the lower part of the pores. In this case, the barrier layer can easily be removed by performing an etching treatment known in the art using an etching solution known in the art such as phosphoric acid or the like. In this way, pores which expose the soft magnetic underlayer or substrate can be formed in the layer of porous layer-forming material substantially perpendicular to the substrate plane.

Due to the porous layer forming process, a porous layer is formed on the substrate or soft magnetic underlayer.

The soft magnetic layer forming process is a process for forming a soft magnetic layer inside the pores.

This soft magnetic layer can be formed by depositing or filling the interior of the pores with the material of the soft magnetic layer by electrodeposition or the like.

The electrodeposition conditions are not particularly limited and may be suitably selected according to the purpose, e.g., the material can be precipitated or deposited on the electrode by applying a voltage using one, two or more solutions containing the material of the soft magnetic layer, with the soft magnetic underlayer or electrode layer as an electrode.

Due to the soft magnetic layer forming process, the soft magnetic layer is formed inside the pores of the porous layer on the substrate, on the soft magnetic underlayer or on the electrode layer.

The ferromagnetic layer forming process is a process for forming the ferromagnetic layer on the soft magnetic layer (or if the nonmagnetic layer is formed on the soft magnetic layer, it is then formed on the nonmagnetic layer).

The ferromagnetic layer may be formed by depositing or filling the material of the ferromagnetic layer on the soft magnetic layer formed inside the pores.

The electrodeposition conditions are not particularly limited and may be suitably selected according to the purpose, e.g., the material can be precipitated or deposited in the pores by applying a voltage using one, two or more solutions containing the material of the ferromagnetic layer, with the soft magnetic underlayer or electrode layer (seed layer) as an electrode.

Due to the ferromagnetic layer forming process, the ferromagnetic layer is formed inside the pores of the porous layer on the soft magnetic layer or on the nonmagnetic layer.

The nonmagnetic layer forming process is a process for forming a nonmagnetic layer on the soft magnetic layer.

The nonmagnetic layer may be formed by depositing or filling the material of the nonmagnetic layer on the soft magnetic layer inside the pores by electrodeposition or the like.

The electrodeposition conditions are not particularly limited and may be suitably selected according to the purpose, e.g., the material can be precipitated or deposited in the pores by applying a voltage using one, two or more solutions containing the material of the nonmagnetic layer, with the soft magnetic underlayer or electrode layer as an electrode.

Due to the nonmagnetic layer forming process, the nonmagnetic layer is formed inside the pores of the porous layer on the soft magnetic layer.

Using the method for manufacturing the magnetic recording medium of the present invention, the magnetic recording media of the present invention can be efficiently manufactured at low cost.

(Magnetic Recording Apparatus and Magnetic Recording Method)

The magnetic recording apparatus of the present invention comprises the magnetic recording medium of the present invention and a perpendicular-magnetic-recording head, and may further comprise other means or members suitably selected as required.

The magnetic recording method of the present invention comprises recording information on the magnetic recording medium of the present invention using the perpendicular-magnetic-recording head, and may further comprise other treatments or processes suitably selected as required. The magnetic recording method is preferably carried out using the magnetic recording apparatus of the present invention. The other treatments or processes can be carried out using the other means or members. The magnetic recording apparatus as well as the magnetic recording method will be illustrated below.

The perpendicular-magnetic-recording head is not particularly limited and may be suitably selected according to the purpose, e.g. a single pole head. The perpendicular-magnetic-recording head may be a write-only head or a read/write head integrated with a read head such as a giant magneto-resistive (GMR) head.

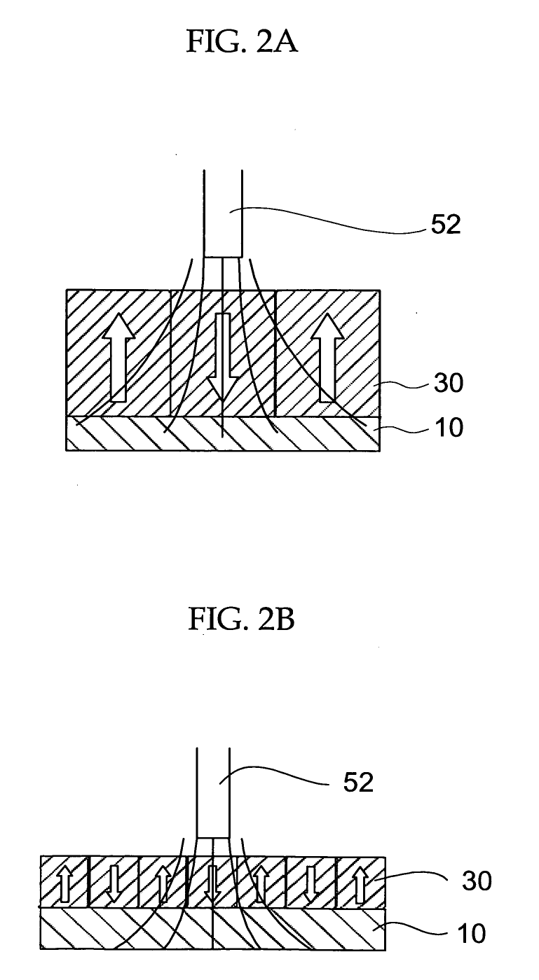

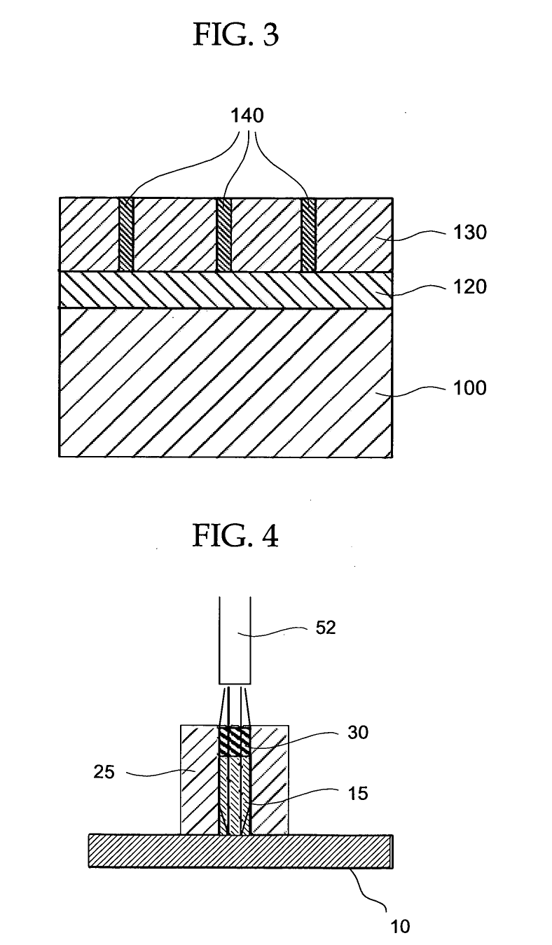

In the magnetic recording apparatus or the magnetic recording method, the magnetic recording medium of the present invention is used in magnetic recording. Thus, the distance between the perpendicular-magnetic-recording head and the soft magnetic layer in the magnetic recording medium is less than the thickness of the porous layer and is substantially equal to the thickness of the ferromagnetic layer. The convergence of a magnetic flux from the perpendicular-magnetic-recording head and the optimum properties for magnetic recording and reproduction at a recording density in practice can therefore be controlled only by controlling the thickness of the ferromagnetic layer, regardless of the thickness of the porous layer. As shown in FIG. 2B, the magnetic flux from a main pole of the perpendicular-magnetic-recording head (read-write head) 52 converges to the ferromagnetic layer (perpendicularly magnetized film) 30. As a result, the magnetic recording apparatus (method) exhibits significantly increased write efficiency, requires a decreased write current and has markedly improved overwrite properties as compared with conventional equivalents.

If the soft magnetic underlayer is formed in the magnetic recording medium, a magnetic circuit is preferably formed between the perpendicular-magnetic-recording head and the soft magnetic underlayer. In this case, high-density recording can be performed which is advantageous.

In magnetic recording by the magnetic recording apparatus of the present invention or magnetic recording by the magnetic recording method of the present invention, the magnetic flux from the perpendicular-magnetic-recording head remains concentrated and does not disperse in the ferromagnetic layer of the magnetic recording medium even in the vicinity of the lower surface of the ferromagnetic layer, i.e., the interface with the soft magnetic layer or nonmagnetic layer. Thus, information can be recorded in small bits.

The convergence degree (dispersion degree) of magnetic flux in the ferromagnetic layer is not particularly limited provided that it does not interfere with the effect of the present invention, and may be suitably selected according to the purpose.

The present invention will be illustrated in further detail with reference to several examples below, which are not intended to limit the scope of the present invention. In the examples below, the magnetic recording medium of the present invention is manufactured by the method for manufacturing the magnetic recording medium of the present invention, magnetic recording is carried out by the magnetic recording apparatus of the present invention, and the magnetic recording method of the present invention is thereby carried out.

### Example 1

A magnetic recording medium was manufactured as follows. a film of CoZrNb as a material for the soft magnetic underlayer was formed on a silicon substrate serving as the substrate by sputtering, to thereby form the soft magnetic underlayer with a thickness of 500 nm thick. This is the soft magnetic underlayer forming process in the method for manufacturing the magnetic recording medium of the present invention.

Next, an aluminum layer was formed on the soft magnetic underlayer by sputtering using aluminium (Al) with a purity of 99.995% as the target to thereby form the layer of porous layer-forming material 500 nm thick. The layer of porous layer-forming material was subjected to pores forming treatment by anodization at 10° C. and an applied voltage of 25 V using the soft magnetic underlayer (CoZrNb) as an electrode in an aqueous solution of sulfuric acid, and pores were formed to thereby form alumite pores (pore pitch (cell diameter): 60 nm, pore diameter: 40 nm, aspect ratio: 12.5, honeycomb arrangement) as the porous layer. The anodized alumite pores as the porous layer had a barrier layer at their bottom, and the barrier layer was removed by etching with phosphoric acid to expose the soft magnetic underlayer (CoZrNb) to thereby convert the pores into through holes. This is the porous layer forming process in the method for manufacturing the magnetic recording medium of the present invention.

Next, a layer of NiFe about 250 nm thick as the soft magnetic layer was formed inside the pores of the porous layer (alumite pores) by electrodeposition in a bath housing a solution containing nickel sulfate and iron sulfate using the soft magnetic underlayer (CoZrNb) as the electrode under the application of a negative voltage. The composition of the nickel sulfate and iron sulfate in the solution was a permalloy composition (Ni80%—Fe20%). This is the soft magnetic layer forming process in the method for manufacturing the magnetic recording medium of the present invention.

Subsequently, a layer of FeCo as the ferromagnetic layer was formed on the soft magnetic layer inside the pores of the porous layer (alumite pores) by electrodeposition using a solution containing FeCo instead of the above solution containing cobalt sulfate and iron sulfate. This is the ferromagnetic layer forming process in the method for manufacturing the magnetic recording medium of the present invention.

Next, after polishing the surface of the porous layer, a film of SiO₂ as the protective film was formed by sputtering. Further, the article was subjected to burnishing and lubricating to thereby yield Sample Disk A as the magnetic recording medium of the present invention. The ferromagnetic layer in Sample Disk A had a thickness of 250 nm.

Herein, for comparison, Sample Disk B (comparative example) was manufactured in the same way as in Sample Disk A, except that, in Sample Disk A, the soft magnetic layer was not formed and the ferromagnetic layer alone was formed inside the pores of the porous layer (alumite pores) (to a thickness equal to the total thickness of the ferromagnetic layer and soft magnetic layer in Sample Disk A).

Also, Sample disk C (comparative example) was manufactured in the same way as in Sample Disk A, except that, in Sample Disk A, the soft magnetic layer was not formed and after polishing the porous layer (alumite pores) to a thickness of 250 nm, the ferromagnetic layer alone was formed inside the pores (to the same thickness as that of the ferromagnetic layer in Sample Disk A).

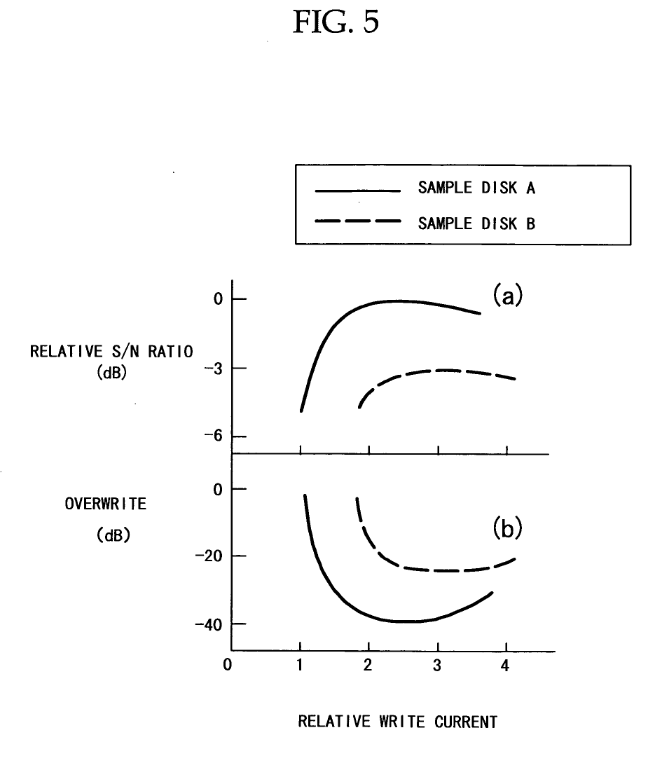

Magnetic recording was carried out and recording-reproducing properties were determined on each of the above-manufactured Sample Disks A, B and C. Specifically, using a magnetic recording apparatus having a single pole head as a write magnetic head and a GMR head as readout magnetic head, signals were written on the disk with the single pole head and read out with the GMR head. FIG. 5 shows the results. The upper part (a) of FIG. 5 is a graph showing a relationship between the write current at 400 kBPI corresponding to 60 nm pitches and the signal-to-noise ratio S/N of the reproduced signal. The lower part (b) of FIG. 5 below the horizontal axis was a graph showing the overwrite properties as a function of the write current, in which signals of 200 kBPI with large bits were written, and then signals of 400 kBPI with small bits were overwritten, and the degree of unerased 200-kBPI signals (unerased large bits) was evaluated.

FIG. 5 shows that Sample Disk A (magnetic recording medium of the present invention) has a more satisfactory S/N ratio and overwrite properties than Sample Disk B (magnetic recording medium as the comparative example). Sample Disk C (magnetic recording medium as the comparative example) showed a defected output envelop in one round of the disk to thereby fail to provide accurate data. This is probably because of irregular thickness of the disk due to a large amount of polishing.

### Example 2

Sample Disk was manufactured in the same way as in Example 1, except that, in Example 1, the substrate was changed from a silicon substrate to an aluminum substrate, this aluminum substrate was used as an electrode, and a layer of permalloy (Ni 80%—Fe 20%) 500 nm thick as the soft magnetic underlayer was formed instead of the soft magnetic underlayer of CoZrNb by electrodeposition using a solution containing nickel sulfate and iron sulfate.

When the same evaluation as in Example 1 was performed for Sample Disk of Example 2, it was found that Sample Disk of Example 2 had the same magnetic recording properties as those of Sample Disk A of Example 1.

### Example 3

Various Sample Disks were manufactured wherein, in the Sample Disks A and B of Example 1, the material for the soft magnetic layer was respectively replaced by FeSiAl, FeC, FeCoB, FeCoNiB, CoZrNb, and the material for the ferromagnetic layer was respectively replaced by Fe, Co, Ni, FeNi, CoNi, CoNiP and FePt, CoPt, NiPt. These Sample Disks were evaluated in the same way as in Example 1 to obtain the results corresponding to those of Sample Disks A and B of Example 1. Specifically, it was found that these Sample Disks of Example 3 had the magnetic recording properties shown in FIG. 5.

### Example 4

A magnetic recording medium was manufactured as follows. Initially, a film of NiFe (Ni80%—Fe20%) as the material for the soft magnetic underlayer was formed by sputtering on a silicon substrate serving as the substrate to thereby yield the soft magnetic underlayer 500 nm thick. This is the soft magnetic underlayer forming process in the method for manufacturing the magnetic recording medium of the present invention.

Next, an aluminum layer was formed on the soft magnetic underlayer by sputtering using aluminium (Al) with a purity of 99.995% as the target to thereby form the layer of porous layer-forming material 500 nm thick. The layer of porous layer-forming material was subjected to pores forming treatment by anodizing the layer by the anodic oxidation method at 4° C. and an applied voltage of 3 V using the soft magnetic underlayer (NiFe) as an electrode in an aqueous solution of sulfuric acid, and pores were formed to thereby form alumite pores (pore pitch (cell diameter): 20 nm, pore diameter: 13 nm, aspect ratio: 38.5, honeycomb arrangement) as the porous layer. The alumite pores as the porous layer had a barrier layer at their bottom, and the barrier layer was removed by etching with phosphoric acid to expose the soft magnetic underlayer (NiFe) to thereby convert the pores into through holes. This is the porous layer forming process in the method for manufacturing the magnetic recording medium of the present invention.

Next, a layer of NiFe about 470 nm thick as the soft magnetic layer was formed inside the pores of the porous layer (alumite pores) by electrodeposition in a bath housing a solution containing nickel sulfate and iron sulfate using the soft magnetic underlayer (NiFe) as the electrode under the application of a negative voltage. The composition of the nickel sulfate and iron sulfate in the solution was a permalloy composition (Ni80%—Fe20%). This is the soft magnetic layer forming process in the method for manufacturing the magnetic recording medium of the present invention.

Next, a layer of Cu as the nonmagnetic layer about 5 nm thick was formed on the soft magnetic layer inside the pores of the porous layer (alumite pores) by electrodeposition using the soft magnetic underlayer (NiFe) as the electrode under the application of a negative voltage in a bath housing a solution containing copper sulfate. This is the nonmagnetic layer forming process in the method for manufacturing the magnetic recording medium of the present invention.

Next, a layer of CoPt as the ferromagnetic layer was formed on the nonmagnetic layer inside the pores of the porous layer (alumite pores) by electrodeposition using a solution containing cobalt sulfate and hexachloroplatinic acid instead of the solution in the bath. This is the ferromagnetic layer forming process in the method for manufacturing the magnetic recording medium of the present invention.

After polishing a surface of the porous layer, a film of SiO₂ was formed thereon by sputtering to form the protective layer 3 nm thick. Further, the article was subjected to burnishing and lubricating to thereby yield Sample Disk K as the magnetic recording medium of the present invention. The ferromagnetic layer in Sample Disk K had a thickness of 20 nm.

As a comparative disk, Sample Disk L was manufactured in the same manner as in Sample Disk K, except that the porous layer and the soft magnetic layer were not formed and that the nonmagnetic layer (Cu) and the ferromagnetic layer (CoPt) were formed on the soft magnetic underlayer (NiFe (Ni80%—Fe20%)) to have the same composition and thickness as in Sample Disk K.

Signals were written by magnetic recording on above-manufactured Sample Disks K and L by the procedure of Example 1, except for using a magnetic recording apparatus having a single pole head (magnetic pole size: 20 nm) as a write magnetic head. Signals were written by magnetic recording on above-manufactured Sample Disks K and L by the procedure of Example 1, except for using a magnetic recording apparatus having a single pole head (magnetic pole size: 20 nm) as a write magnetic head. In this procedure, the single pole head was floated 5 nm over the medium.

The recorded portions in Sample Disks K and L were observed with a magnetic force microscope. As a result, in Sample Disk K, light portions and dark portions of a minimum size of 20 nm corresponding to the orientation of magnetization were observed in the recorded portions, showing that each of the pores (alumite pore) filled with the magnetic material constitutes a single domain. In contrast, in Sample Disk L, no magnetization pattern corresponding to the recording frequency was observed at the same write current (under the same write conditions) as in Sample Disk K, and a recording pattern with a recording bit length of 30 nm or more was observed at a write current 1.5 times or more of that in Sample Disk K. This magnetization pattern had irregular dimensions. These results show that Sample Disk K according to the present invention may enable recording in bits each having a size of 20 nm at a recording density of 1.6 Tb/in².

The present invention solves the problems in conventional technologies and provides a high-quality, high-capacity magnetic recording medium which is useful in, for example, hard disk devices widely used as external storage for computers and consumer-oriented video recorders, enables recording of information at high density and high speed without increasing a write current of a magnetic head and exhibits satisfactory and uniform properties such as overwrite properties; a method for efficiently manufacturing the magnetic recording medium at low cost; and an apparatus and method for perpendicular magnetic recording using the magnetic recording medium, which enable high-density recording.

1. A magnetic recording medium comprising:
a substrate; and
a porous layer on or above the substrate, which porous layer comprises a plurality of pores, the pores each extending in a direction substantially perpendicular to a substrate plane,
wherein the pores each have a soft magnetic layer and a ferromagnetic layer inside in this order from the substrate side, and
wherein the ferromagnetic layer has a thickness equal to or less than that of the soft magnetic layer.

2. A magnetic recording medium according to claim 1, wherein the ferromagnetic layer has a thickness one-thirds to three times a minimum bit length, the minimum bit length being determined by a linear recording density in recording.

3. A magnetic recording medium comprising:
a substrate; and
a porous layer on or above the substrate, which porous layer comprises a plurality of pores, the pores each extending in a direction substantially perpendicular to a substrate plane,
wherein the pores each have a soft magnetic layer and a ferromagnetic layer inside in this order from the substrate side, and
wherein the ferromagnetic layer has a thickness one-thirds to three times a minimum bit length, the minimum bit length being determined by a linear recording density in recording.

4. A magnetic recording medium according to claim 3, further comprising a soft magnetic underlayer between the substrate and the porous layer.

5. A magnetic recording medium according to claim 4, wherein the ferromagnetic layer has a thickness equal to or less than the total thickness of the soft magnetic layer and the soft magnetic underlayer.

6. A magnetic recording medium comprising:
a substrate;
a soft magnetic underlayer on the substrate; and
a porous layer on the soft magnetic underlayer, which porous layer comprises a plurality of pores, the pores each extending in a direction substantially perpendicular to a substrate plane,
wherein the pores each have a soft magnetic layer and a ferromagnetic layer inside in this order from the substrate side, and
wherein the ferromagnetic layer has a thickness equal to or less than the total thickness of the soft magnetic layer and the soft magnetic underlayer.

7. A magnetic recording medium according to claim 6, further comprising a nonmagnetic layer between the ferromagnetic layer and the soft magnetic layer.

8. A magnetic recording medium according to claim 6, wherein the porous layer comprises alumite.

9. A magnetic recording medium according to claim 6, wherein the pores have an aspect ratio of 2 or more, and wherein the aspect ratio is the ratio A/B of A the depth of a pore to B the diameter of opening thereof.

10. A magnetic recording medium according to claim 6, wherein the pores have an opening diameter of 100 nm or less and are arranged in a honeycomb array.

11. A magnetic recording medium according to claim 6, wherein the porous layer has a thickness of 500 nm or less.

12. A magnetic recording medium according to claim 6, wherein the ferromagnetic layer comprises at least one selected from the group consisting of Fe, Co, Ni, FeCo, FeNi, CoNi, CoNiP, FePt, CoPt and NiPt.

13. A magnetic recording medium according to claim 6, wherein the soft magnetic layer comprises at least one selected from the group consisting of NiFe, FeSiAl, FeC, FeCoB, FeCoNiB and CoZrNb.

14. A magnetic recording medium according to claim 6, wherein the soft magnetic layer in the pores has an axis of easy magnetization in a direction substantially perpendicular to the substrate plane.

15. A magnetic recording medium according to claim 6, which is a magnetic disk.

16. A method for manufacturing a magnetic recording medium, comprising the processes of:
forming a porous layer which comprises a plurality of pores;
forming a soft magnetic layer inside the pores; and
forming a ferromagnetic layer on the soft magnetic layer,
wherein the process of forming a porous layer comprises:
forming a layer of porous layer-forming material on or above a substrate; and
treating the layer of porous layer-forming material to form the pores extending in a direction substantially perpendicular to a substrate plane to thereby form the porous layer,
wherein the magnetic recording medium comprises:
a substrate; and
a porous layer on or above the substrate, which porous layer comprises a plurality of pores, the pores each extending in a direction substantially perpendicular to a substrate plane,
wherein the pores each have a soft magnetic layer and a ferromagnetic layer inside in this order from the substrate side, and
wherein the ferromagnetic layer has a thickness equal to or less than that of the soft magnetic layer.

17. A method for manufacturing a magnetic recording according to claim 16, wherein the porous layer-forming material is aluminum.

18. A method for manufacturing the magnetic recording medium according to claim 16, wherein the process of treating the layer of porous layer-forming material comprises anodizing the layer of porous layer-forming material.

19. A method for manufacturing the magnetic recording medium according to claim 16, further comprising the process of forming a soft magnetic underlayer on the substrate, wherein the porous layer is formed on the soft magnetic underlayer.

20. A magnetic recording apparatus comprising:
a magnetic recording medium; and
a perpendicular-magnetic-recording head,
wherein the magnetic recording medium comprises:
a substrate; and
a porous layer being arranged on or above the substrate, which porous layer comprises a plurality of pores, the pores each extending in a direction substantially perpendicular to a substrate plane,
wherein the pores each have a soft magnetic layer and a ferromagnetic layer inside in this order from the substrate side, and
wherein the ferromagnetic layer has a thickness equal to or less than that of the soft magnetic layer.
